(19) United States
(12) Patent Application Publication
(10) Pub. No.: US 2009/0055846 A1
(43) Pub. Date: Feb. 26, 2009

(54) OPTICAL DISK DRIVE APPARATUS

(75) Inventor: Yasuki Torigoshi, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/107,523

(22) Filed: Apr. 22, 2008

(30) Foreign Application Priority Data
Aug. 20, 2007 (JP) 2007-213881

(51) Int. Cl. G11B 17/03

(52) U.S. Cl. 720/601

(57) ABSTRACT

According to one embodiment, an optical disk drive apparatus has a case, a disk tray, a first connector, a second connector, and a positioning mechanism. The first connector is provided on the case. The second connector is provided on the disk tray, has a conduction with the first connector when the disk tray is in a first position, and is separated from the first connector when the disk tray is in a second position. The positioning mechanism is provided between the case and the disk tray, and positions the second connector with respect to the first connector when the disk tray moves from the second position to the first position.

### CROSS-REFERENCE TO RELATED APPLICATIONS

This application is based upon and claims the benefit of priority from Japanese Patent Application No. 2007-213881, filed Aug. 20, 2007, the entire contents of which are incorporated herein by reference.

### BACKGROUND

1. Field

One embodiment of the invention relates to an optical disk drive apparatus, in which a case and a disk tray are connected by a connector.

2. Description of the Related Art

For example, Jpn. Pat. Appln. KOKAI Pub. No. 2005-44492 discloses an optical disk apparatus in which a flexible print cable for connecting the circuit board of a case with the circuit board of a tray is omitted. The optical disk apparatus has a case, a tray which projects from the case and is retracted into the case, a first circuit board provided in the case, a second circuit board provided in the tray, and a connector provided between the first circuit board and the second circuit board. The connector has one terminal connected to the first circuit board, and the other terminal connected to the second circuit board.

In the optical disk apparatus, said one terminal and the other terminal are connected in the state where the tray is retracted into the case, and electrical conduction is established between the first circuit board and the second circuit board. Further, when the tray projects from the case, the first circuit board and the second circuit are brought out of conduction. As described above, in the optical disk apparatus, a connector is provided between the first circuit board and the second circuit board, and thereby a flexible print cable is unnecessary.

However, in the above optical disk apparatus of prior art, positioning of the tray and the case becomes a problem when connecting the connector. However, no consideration is given to positioning between the tray and the case in the above optical disk apparatus. Therefore, if the setting position of the tray is shifted for any reason, load is put on the connector when the tray is projected or retracted, and there is a fear that the connector deteriorates early.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary cross-sectional view along a horizontal direction of a DVD drive apparatus according to a first embodiment.

FIG. 2 is an exemplary cross-sectional view illustrating a state where a disk tray of the DVD drive apparatus illustrated in FIG. 1 is in a first position.

FIG. 3 is an exemplary cross-sectional view along a vertical direction of the DVD drive apparatus illustrated in FIG. 1.

FIG. 4 is an exemplary cross-sectional view along a horizontal direction of a DVD drive apparatus according to a second embodiment.

FIG. 5 is an exemplary cross-sectional view illustrating a state where a disk tray of the DVD drive apparatus illustrated in FIG. 4 is in a first position.

FIG. 6 is an exemplary cross-sectional view along a vertical direction of the DVD drive apparatus illustrated in FIG. 4.

FIG. 7 is an exemplary cross-sectional view along a horizontal direction of a DVD drive apparatus according to a third embodiment.

FIG. 8 is an exemplary cross-sectional view illustrating a state where a disk tray of the DVD drive apparatus illustrated in FIG. 7 is in a first position.

FIG. 9 is an exemplary cross-sectional view along a vertical direction of the DVD drive apparatus illustrated in FIG. 7.

### DETAILED DESCRIPTION

Various embodiments according to the invention will be described hereinafter with reference to the accompanying drawings. In general, according to one embodiment of the invention, an optical disk drive apparatus has a case, a disk tray, a first connector, a second connector, and a positioning mechanism. The first connector is provided on the case. The second connector is provided on the disk tray, has a conduction with the first connector when the disk tray is in a first position, and is separated from the first connector when the disk tray is in a second position. The positioning mechanism is provided between the case and the disk tray, and positions the second connector with respect to the first connector when the disk tray moves from the second position to the first position.

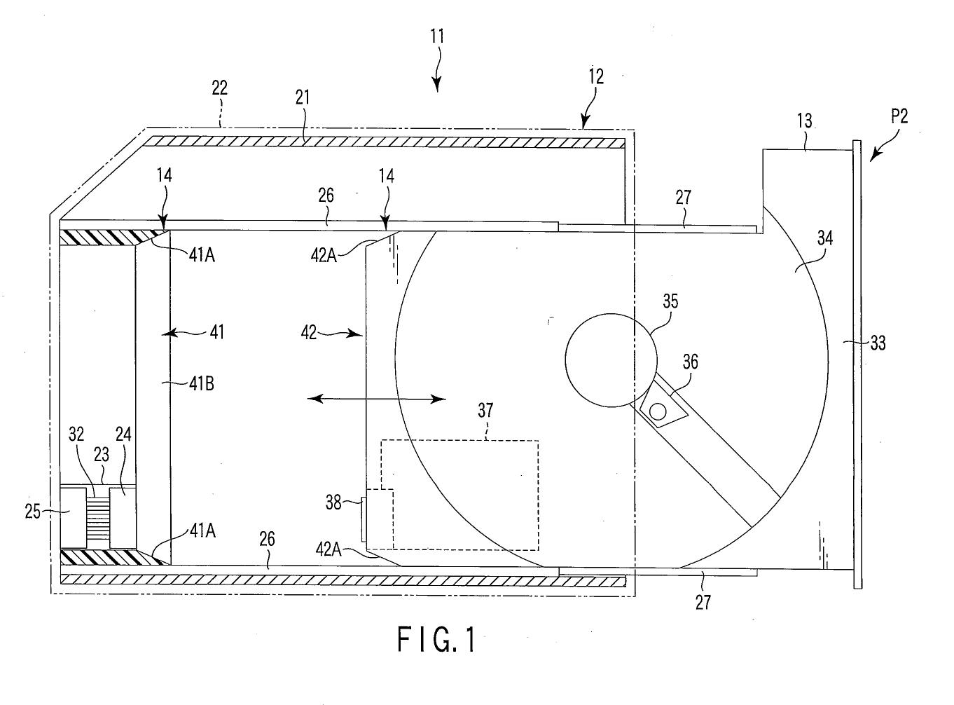

A first embodiment of an optical disk drive apparatus of the present invention is explained below with reference to FIGS. 1 to 3, with a case where the first embodiment is applied to a Digital Versatile Disk (DVD) drive apparatus.

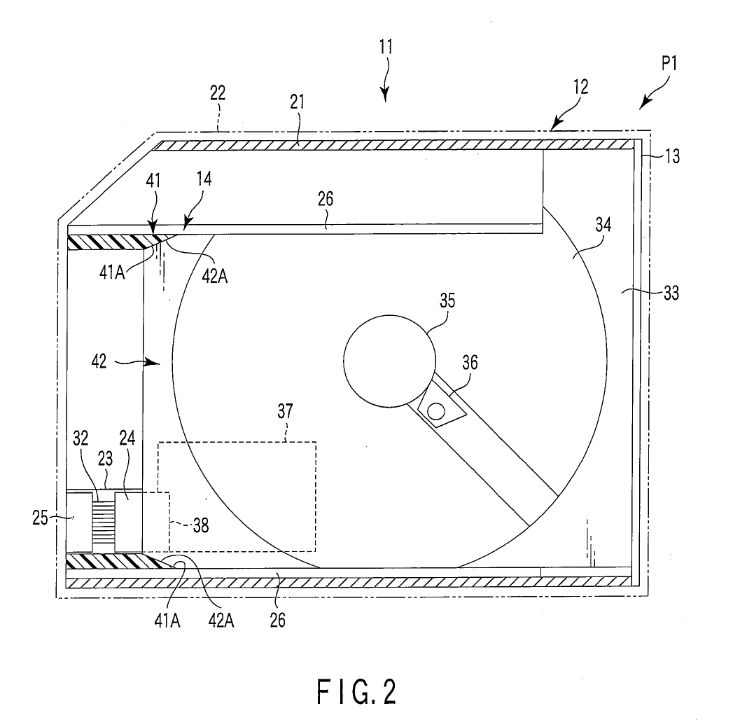

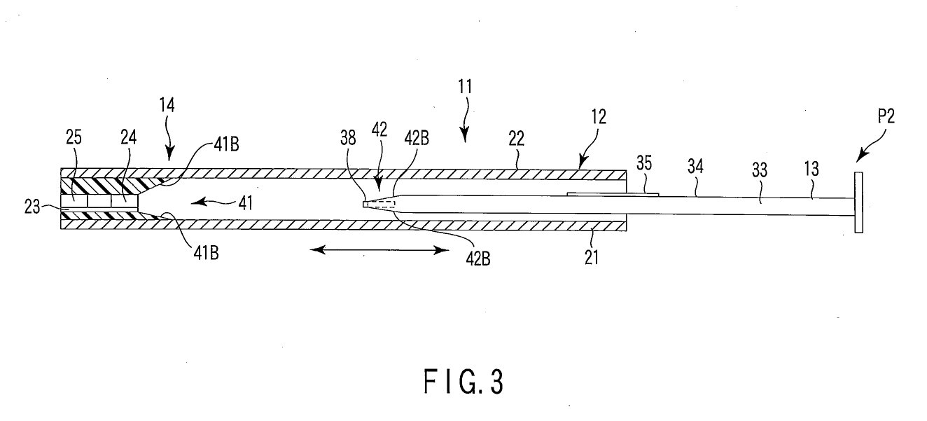

As illustrated in FIGS. 1 to 3, a DVD drive apparatus 11 has a case 12, a disk tray 13 which can move in the forward and backward directions with respect to the case 12, and a positioning mechanism 14 to position the disk tray 13 with respect to the case 12. The disk tray 13 is movable between a first position P1 in which the disk tray 13 is retracted into the case 12 as illustrated in FIG. 2, and a second position P2 in which the disk tray 13 projects from the case 12 to the outside as illustrated in FIGS. 1 and 3. The disk tray 13 can further move forward from the state illustrated in FIGS. 1 and 3, and an optical disk (not shown) can be set on the disk tray 13 and removed from the disk tray 13.

The case 12 has a base portion 21, a cover 22 which surrounds the base portion 21, a first printed circuit board 23 attached to the base portion 21, a first connector 24 and a main connector 25 which are fixed on the first printed circuit board 23, and guide groove portions 26 to guide rails 27 of the disk tray 13 explained later. The first connector 24 and the main connector 25 are electrically connected to the first printed circuit board 23. The main connector 25 secures electrical connection between a printed circuit board of a personal computer and the DVD drive apparatus 11, when the DVD drive apparatus 11 is mounted in the personal computer. The first printed circuit board 23 includes a wire 32, and the wire 32 connects the first connector 24 with the main connector 25.

The disk tray 13 has a tray main body 33 made of resin, a mount portion 34 which is provided on the tray main body 33 and on which an optical disk is placed, a disk motor 35 provided in a central portion of the mount portion 34, a pickup module 36 provided on the mount portion 34, a second printed circuit board 37 attached to the tray main body 33, a second connector 38 fixed on the second printed circuit board 37, and a pair of rails 27 provided on side portions of the tray main body 33. The second connector 38 is electrically connected to the second printed circuit board 37.

As illustrated in FIG. 2, when the disk tray 13 is in the first position P1, the second connector 38 is connected to the first connector 24 and electrically connected to the first connector 24. Further, as illustrated in FIGS. 1 and 3, the second connector 38 is separated from the first connector 24 when the disk tray 13 is in the second position P2.

The positioning mechanism 14 is provided between the case 12 and the disk tray 13. Specifically, the positioning mechanism 14 has a depressed portion 41 attached to the base portion 21, and a projecting portion 42 attached to a base portion of the tray main body 33 of the disk tray 13.

As illustrated in FIG. 1, the projecting portion 42 has a trapezoidal shape as viewed from above. The projecting portion 42 has a pair of right and left first slide portions 42A, and the first slide portions 42A are inclined with respect to the forward/backward directions of the disk tray 13. As illustrated in FIG. 3, the projecting portion 42 has a trapezoidal shape as viewed from the side. The projecting portion 42 has a pair of upper and lower second slide portions 42B, and the second slide portions 42B are inclined with respect to the forward/backward directions of the disk tray 13. Specifically, the projecting portion 42 is tapered from the second position P2 toward the first position P1. A base portion of the second connector 38 is embedded in the projecting portion 42.

As illustrated in FIG. 1, the depressed portion 41 has a cross section of expanding toward the disk tray 13 as viewed from above. The depressed portion 41 has a pair of right and left guide portions 41A, and the first guide portions 41A are inclined with respect to the forward/backward directions of the disk tray 13. As illustrated in FIG. 3, the depressed portion 41 has a cross section of expanding toward the disk tray 13 as viewed from the side. The depressed portion 41 has a pair of upper and lower second guide portions 41B, and the second guide portions 41B are inclined with respect to the forward/backward directions of the disk tray 13. Specifically, the depressed portion 41 expands from the first position P1 toward the second position P2, and has a shape complementary with the projecting portion 42. As illustrated in FIG. 2, when the disk tray 13 is in the first position P1, the projecting portion 42 is inserted into the depressed portion 41. The first connector 24 is disposed in a position corresponding to the bottom portion of the depressed portion 41.

Next, the following is an explanation of function of the positioning mechanism 14 when the disk tray 13 is receded from the second position P2 to the first position P1, with a case where the position of the disk tray 13 is leaning toward a lower right position. When the disk tray 13 moves from the second position P2 to the first position P1, the right first slide portion 42A of the projecting portion 42 contacts the right first guide portion 41A of the depressed portion 41. In the same manner, the second slide portion 42B located in the lower portion of the projecting portion 42 contacts the second guide portion 41B located in the lower portion of the depressed portion 41. Then, when the disk tray 13 is further receded, the disk tray 13 is guided into a desired position by the first guide portions 41A and the second guide portions 41B. Thereby, as illustrated in FIG. 2, the second connector 38 is accurately positioned with respect to the first connector 24, and the first connector 24 and the second connector 38 are correctly connected. Thus, the first connector 24 and the second connector 38 are electrically connected together. Also in the cases where the disk tray 13 is leaning to other directions, the disk tray 13 is guided into the correct position in the same manner by the first guide portions 41A and the second guide portions 41B.

According to the first embodiment explained above, the DVD drive apparatus 11 has the case 12, the disk tray 13 which can move back and forth between the first position P1 where the disk tray 13 is retracted into the case 12 and the second position P2 where the disk tray 13 projects from the case 12 to the outside, the first printed circuit board 23 provided on the case 12, the second printed circuit board 37 provided on the disk tray 13, the first connector 24 provided on the case 12 and connected to the first printed circuit board 23, the second connector 38 which is provided on the disk tray 13, connected to the second printed circuit board 37, has conduction with the first connector 24 when the disk tray 13 is in the first position P1, and separated from the first connector 24 when the disk tray 13 is in the second position P2, and the positioning mechanism 14 which is provided between the case 12 and the disk tray 13 and positions the second connector 38 with respect to the first connector 24 when the disk tray 13 moves from the second position P2 to the first position P1.

According to the above structure, there is no need for providing a flexible print cable between the disk tray 13 and the case 12, and thus the length of the wire is shortened. Thereby, even in the case where data transfer is performed at high speed as with Serial ATA and Serial ATA II, it is possible to prevent generation of electromagnetic waves being undesired radiation from a flexible print cable. Further, since no flexible print cable is necessary, it is possible to reduce the influence of noise from the outside to a minimum. Furthermore, in recent years, the transfer standard used for optical disk drive apparatuses is Serial ATA which serves a high-speed transfer path, and strict specifications are required for transfer wire. According to the structure of connecting the case 12 and the disk tray 13 by a connector as in the first embodiment, the transfer characteristic satisfying the Serial ATA standard can be easily obtained.

Further, since no flexible print cable is necessary, it is possible to configure the disk tray 13 to be removable with respect to the case 12. Thereby, it is possible to easily perform change in breakdown and upgrade to high-line models, only by changing the disk tray 13. As an example of upgrade, it is possible to change a DVD-ROM to a large-capacity High-Definition Digital Versatile Disk (HD DVD).

Furthermore, since the second connector 38 can be accurately positioned with respect to the first connector 24, the second connector 38 is prevented from being inserted in a shifted state into the first connector 24, and the durability of the first connector 24 and the second connector 38 can be improved.

In this case, the positioning mechanism 14 has the projecting portion 42 which is provided in the base portion of the disk tray 13 and tapered from the second position P2 toward the first position P1, and the depressed portion 41 which is provided in the case 12 and has a shape complementary with the projecting portion 42, and into which the projecting portion 42 is inserted when the disk tray 13 moves from the second position P2 to the first position P1. According to the structure, it is possible to realize a high-accuracy positioning mechanism 14 with a simple structure.

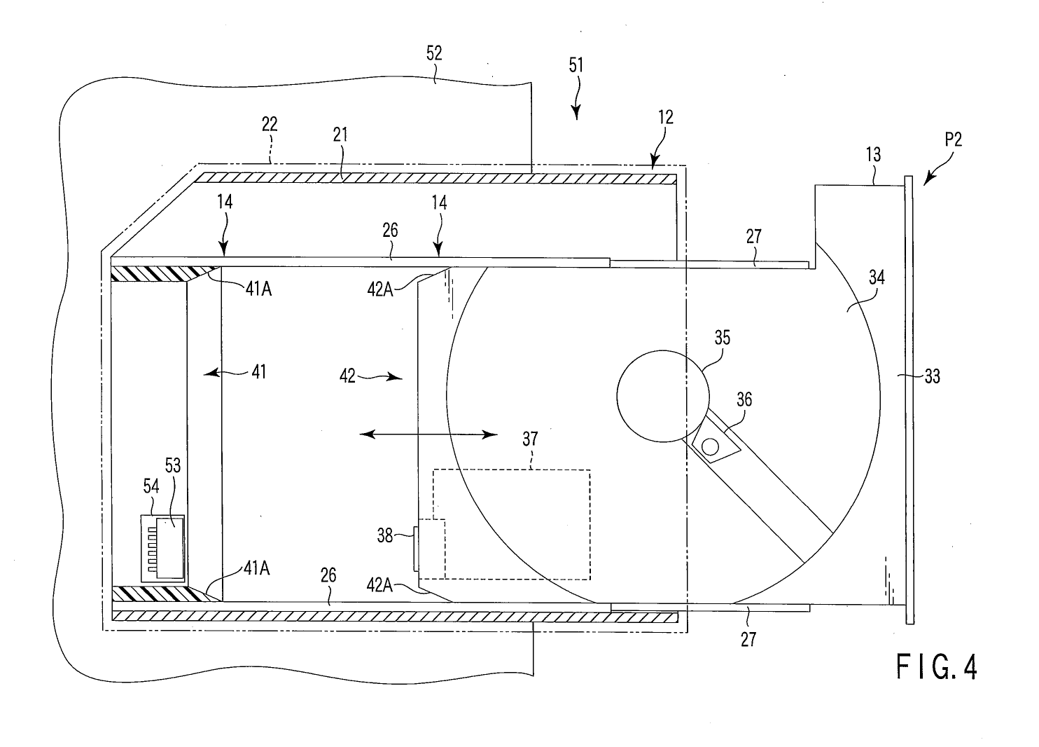

Next, a second embodiment of the optical disk drive apparatus of the present invention is explained with reference to FIGS. 4 to 6, with a case where the second embodiment is applied to a DVD drive apparatus. A DVD drive apparatus 51 of the second embodiment is different from the first embodiment in arrangement of a first printed circuit board 52 and the shape of a first connector 53, although the other parts of the DVD drive apparatus 51 are the same as those of the first embodiment. Therefore, only the parts different from the first embodiment are mainly explained, and the constituent elements which are the same as those of the first embodiment are denoted by the same respective reference numerals, and explanation thereof is omitted.

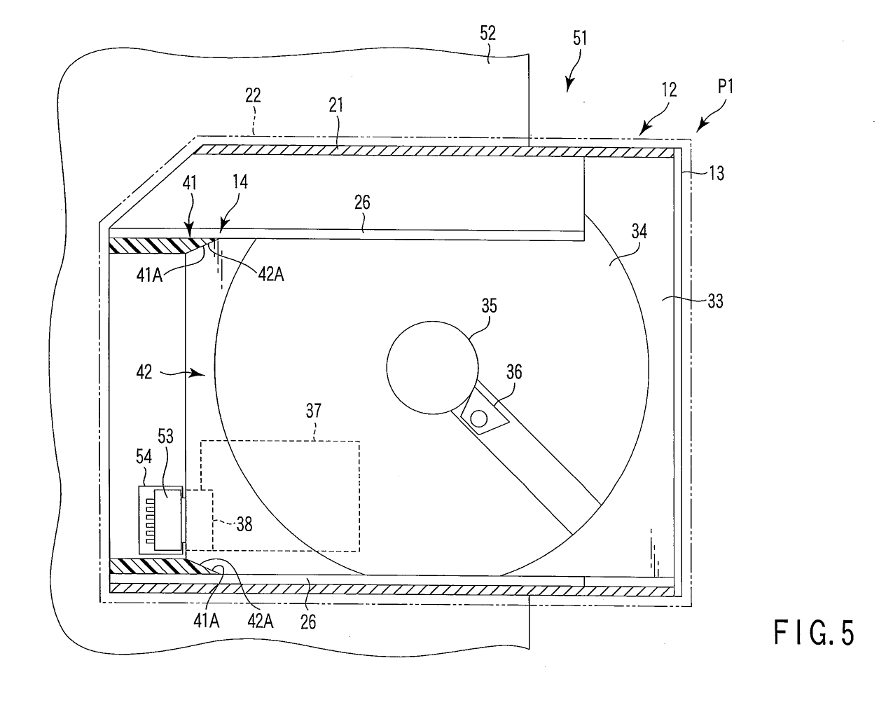

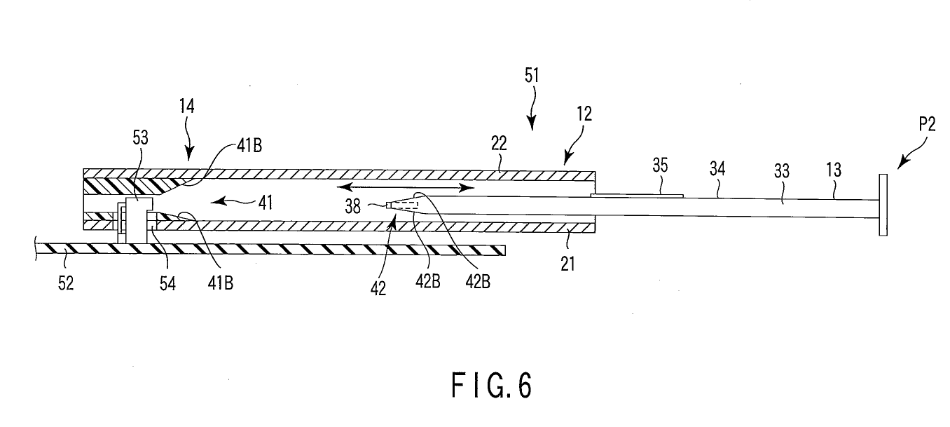

The DVD drive apparatus 51 according to the second embodiment is mounted inside a housing of a personal computer. As illustrated in FIG. 4, the DVD drive apparatus 51 has a case 12, a disk tray 13 which can move in forward and backward directions with respect to the case 12, and a positioning mechanism 14 to position the disk tray 13 with respect to the case 12. The disk tray 13 is movable between a first position P1 where the disk tray 13 is retracted into the case 12 as illustrated in FIG. 5, and a second position P2 where the disk tray 13 projects from the case 12 to the outside as illustrated in FIGS. 4 and 6.

On the other hand, the personal computer has a first print circuit board 52 outside the case 12 of the DVD drive apparatus 51, inside the housing thereof. The printed circuit board 52 has a CPU and the like, and serves as a main board of the personal computer. A first connector 53 to connect to the disk tray 13 is mounted on the first printed circuit board 52. The DVD drive apparatus 51 according to the present invention is defined as including the first printed circuit board 52 and the first connector 53.

The case 12 has a base portion 21, a cover 22 which surrounds the base portion 21, and guide groove portions 26 to guide rails 27 of the disk tray 13 explained later. The base portion 21 has an opening portion 54 through which the first connector 53 passes. The first connector 53 passes through the opening portion 54, and has a connecting portion to connect with the second connector 38. The connecting portion is disposed inside the case 12.

The disk tray 13 is formed in the same manner as in the first embodiment. The disk tray 13 has a second printed circuit board 37 attached to the tray main body 33, and a second connector 38 fixed on the second printed circuit board 37. The second connector 38 is electrically connected to the second printed circuit board 37.

As illustrated in FIG. 5, when the disk tray 13 is in the first position P1, the second connector 38 is connected to the first connector 53 and has an electrical conduction with the first connector 53. Further, as illustrated in FIGS. 4 and 6, the second connector 38 is separated from the first connector 53 when the disk tray 13 is in the second position P2.

The positioning mechanism 14 is provided between the case 12 and the disk tray 13. Specifically, the positioning mechanism 14 has a depressed portion 41 attached to the base portion 21, and a projecting portion 42 provided in the base portion of the tray main body 33 of the disk tray 13.

As illustrated in FIGS. 4 and 6, the projecting portion 42 and the depressed portion 41 are formed to have the same shapes as those in the first embodiment.

When the disk tray 13 moves from the second position P2 to the first position P1, first slide portions 42A located on the right and left sides of the projecting portion 42 contact respective first guide portions 41A located on the right and left sides of the depressed portion 41, In the same manner, second slide portions 42B located in top and bottom portions of the projecting portions 42 contact respective second guide portions 41B located in top and bottom portions of the depressed portion 41. Further, when the disk tray 13 is further receded, the disk tray 13 is guided into a desired position by the first guide portions 41A and the second guide portions 41B. Thereby, the second connector 38 is accurately positioned with respect to the first connector 53, and the first connector 53 and the second connector 38 are correctly connected.

According to the second embodiment, the DVD drive apparatus 51 has the case 12, the disk tray 13 which can move back and forth between the first position P1 where the disk tray 13 is retracted into the case 12 and the second position P2 where the disk tray 13 projects from the case 12 to the outside, the first printed circuit board 52 provided outside the case 12, the second printed circuit board 37 provided on the disk tray 13, the first connector 53 provided inside the case 12 and connected to the first printed circuit board 52, the second connector 38 which is provided on the disk tray 13, connected to the second printed circuit board 37, has conduction with the first connector 53 when the disk tray 13 is in the first position P1, and separated from the first connector 53 when the disk tray 13 is in the second position P2, and the positioning mechanism 14 which is provided between the case 12 and the disk tray 13 and positions the second connector 38 with respect to the first connector 53 when the disk tray 13 moves from the second position P2 to the first position P1.

According to the above structure, the first printed circuit board 52 being the main board of the personal computer can be directly connected with the second printed circuit board 37 of the disk tray 13 by the first connector 53 and the second connector 38. Thereby, unlike the first embodiment, it is unnecessary to provide a main connector 25 on the case 12, and it is possible to simplify the structure of the apparatus and improve signal transfer efficiency.

In this case, the positioning mechanism 14 has the projecting portion 42 which is provided in the base portion of the disk tray 13 and tapered from the second position P2 toward the first position P1, and the depressed portion 41 which is provided in the case 12 and has a shape complementary with the projecting portion 42, and into which the projecting portion 42 is inserted when the disk tray 13 moves from the second position P2 to the first position P1. According to the structure, it is possible to realize a high-accuracy positioning mechanism 14 with a simple structure.

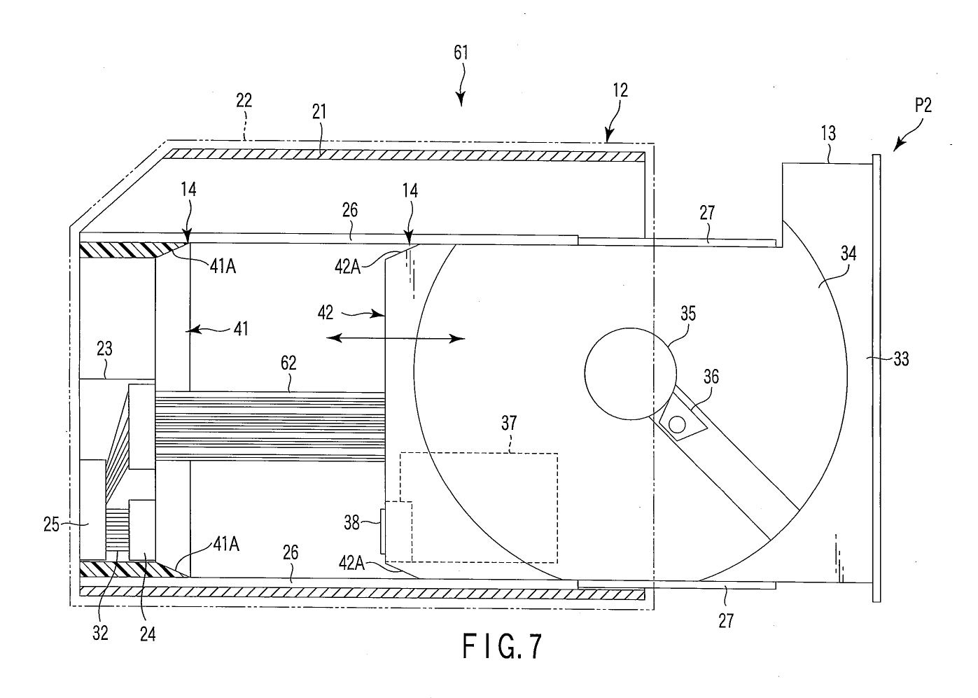

Next, a third embodiment of the optical disk drive apparatus of the present invention is explained with reference to FIGS. 7 to 9, with a case where the third embodiment is applied to a DVD drive apparatus. A DVD drive apparatus 61 of the third embodiment is different from the first embodiment in using a flexible print cable 62, although the other parts of the DVD drive apparatus 61 are the same as those of the first embodiment. Therefore, only the parts different from the first embodiment are mainly explained, and the constituent elements which are the same as those of the first embodiment are denoted by the same respective reference numerals, and explanation thereof is omitted.

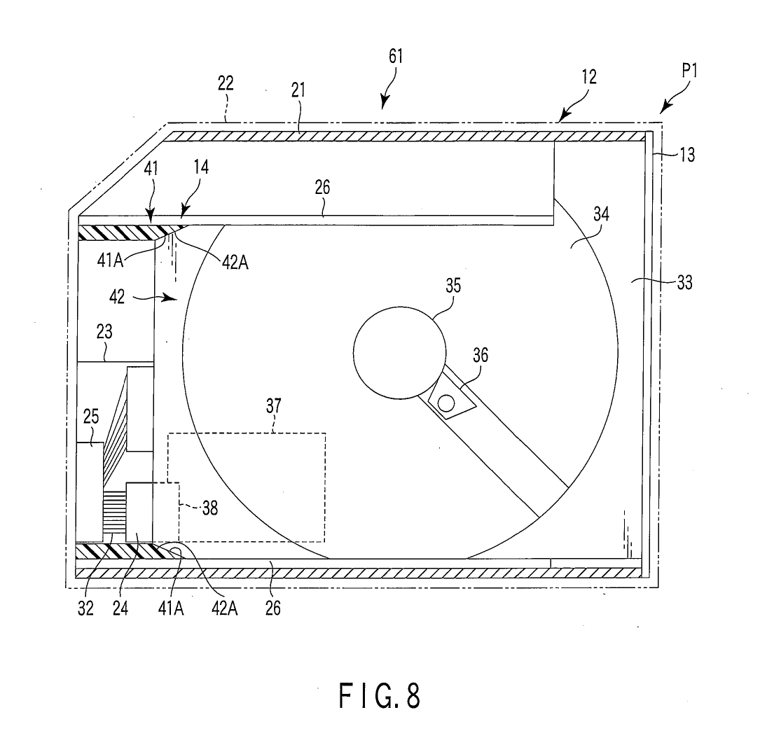

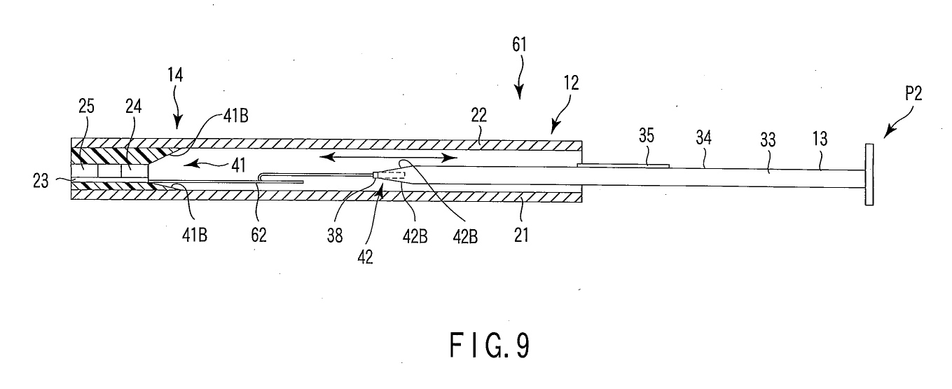

As illustrated in FIG. 7, the DVD drive apparatus 61 has a case 12, a disk tray 13 which can move in forward and backward directions with respect to the case 12, and a positioning mechanism 14 to position the disk tray 13 with respect to the case 12. The disk tray 13 is movable between a first position P1 where the disk tray 13 is retracted into the case 12 as illustrated in FIG. 8, and a second position P2 where the disk tray 13 projects from the case 12 to the outside as illustrated in FIGS. 7 and 9.

The case 12 has a base portion 21, a cover 22 which surrounds the base portion 21, a first printed circuit board 23 attached to the base portion 21, a first connector 24 and a main connector 25 which are fixed on the first printed circuit board 23, and guide groove portions 26 to guide rails 27 of the disk tray 13 explained later. The first connector 24 is electrically connected to the first printed circuit board 23. The first connector 24 has a plurality of pins to exchange high-speed signals.

The disk tray 13 has a tray main body 33 made of resin, a mount portion 34 which is provided on the tray main body 33 and on which an optical disk is placed, a disk motor 35 provided in a central portion of the mount portion 34, a pickup module 36 provided on the mount portion 34, a second printed circuit board 37 attached to the tray main body 33, a second connector 38 fixed on the second printed circuit board 37, and a pair of rails 27 provided on side portions of the tray main body 33. The second connector 38 is electrically connected to the second printed circuit board 37. The second connector 38 has a plurality of pins to exchange high-speed signals.

As illustrated in FIG. 8, when the disk tray 13 is in the first position P1, the second connector 38 is connected to the first connector 24 and has an electrical conduction with the first connector 24. Further, as illustrated in FIGS. 7 and 9, the second connector 38 is separated from the first connector 24 when the disk tray 13 is in the second position P2.

The DVD drive apparatus 61 further includes a flexible print cable 62 which is an electric power line connecting the first printed circuit board 23 of the case 12 and the second printed circuit board 37 of the disk tray 13. The flexible print cable 62 can supply electric power from the first printed circuit board 23 to the second printed circuit board 37. The electric power supplied to the second printed circuit board 37 is further supplied to the disk motor 35 and the pickup module 36. In the DVD drive apparatus 61 of the third embodiment, high-speed signals are transferred through the first connector 24 and the second connector 38, and electric power is transmitted through the flexible print cable 62.

The positioning mechanism 14 is provided between the case 12 and the disk tray 13. Specifically, the positioning mechanism 14 has a depressed portion 41 attached to the base portion 21, and a projecting portion 42 provided in the base portion of the tray main body 33 of the disk tray 13. As illustrated in FIGS. 7 and 9, the projecting portion 42 and the depressed portion 41 are formed in the same shapes as those in the first embodiment.

When the disk tray 13 moves from the second position P2 to the first position P1, first slide portions 42A located on the right and left sides of the projecting portion 42 contact respective first guide portions 41A located on the right and left sides of the depressed portion 41, In the same manner, second slide portions 42B located in top and bottom portions of the projecting portions 42 contact respective second guide portions 41B located in top and bottom portions of the depressed portion 41. Further, when the disk tray 13 is further receded, the disk tray 13 is guided into a desired position by the first guide portions 41A and the second guide portions 41B. Thereby, the second connector 38 is accurately positioned with respect to the first connector 24, and the first connector 24 and the second connector 38 are correctly connected.

According to the third embodiment, the DVD drive apparatus 61 has the case 12, the disk tray 13 which can move back and forth between the first position P1 where the disk tray 13 is retracted into the case 12 and the second position P2 where the disk tray 13 projects from the case 12 to the outside, the first printed circuit board 23 provided on the case 12, the second printed circuit board 37 provided on the disk tray 13, the first connector 24 provided in the case 12 and connected to the first printed circuit board 23, the second connector 38 which is provided on the disk tray 13, connected to the second printed circuit board 37, has conduction with the first connector 24 when the disk tray 13 is in the first position P1, and separated from the first connector 24 when the disk tray 13 is in the second position P2, the flexible print cable 62 which connects the first print circuit board 23 with the second print circuit board 37 and serves as an electric power line supplying electric power from the first print circuit board 23 to the second print circuit board 37, and the positioning mechanism 14 which is provided between the case 12 and the disk tray 13 and positions the second connector 38 with respect to the first connector 24 when the disk tray 13 moves from the second position P2 to the first position P1.

According to the above structure, only signal lines which exchange high-speed signals can be arranged on the first connector 24 and the second connector 38. Thereby, it is possible to reduce electromagnetic waves of undesired radiation radiated from the flexible print cable 62, and reduce the influence of noise from outside. On the other hand, since electric power lines are generally formed of thick wires, the amount of undesired radiation from the flexible print cable 62 is small.

Further, generally, when an electric power line is formed on a connector, a plurality of pins are used as an electric power line from the viewpoint of preventing breakage due to heating. According to the above structure, it is possible to reduce the number of pins used for the first connector 24 and the second connector 38, and reduce the load put on the disk tray 13 when the first connector 24 and the second connector 38 are connected and disconnected. Further, the manufacturing cost of the connectors can be reduced by reducing the number of pins of the connectors.

Although the electric power line is formed by the flexible print cable 62 in the third embodiment, the present invention is not limited to this structure. Specifically, power supply from the first print circuit board 23 to the second print circuit board 37 may be performed through the rails 27 and the guide groove portions 26. According to this structure, the disk tray 13 can be configured to be removable from the case 12, without using a flexible print cable 62.

In this case, the positioning mechanism 14 has the projecting portion 42 which is provided in the base portion of the disk tray 13 and tapered from the second position P2 toward the first position P1, and the depressed portion 41 which is provided in the case 12 and has a shape complementary with the projecting portion 42, and into which the projecting portion 42 is inserted when the disk tray 13 moves from the second position P2 to the first position P1. According to the structure, it is possible to realize a high-accuracy positioning mechanism 14 with a simple structure.

The optical disk drive apparatus of the present invention is not limited to the DVD drive apparatuses 11, 51 and 61, but the present invention can be carried out for other electric apparatuses such as compact disk (CD) drive apparatuses. Further, it goes without saying that the optical disk drive apparatus can be carried out with various modifications within the range of not departing from the gist of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disk drive apparatus comprising:
a case;
a disk tray which is movable back and forth between a first position where the disk tray is retracted into the case and a second position where the disk tray projects from the case to the outside;
a first printed circuit board provided on the case;
a second printed circuit board provided on the disk tray;
a first connector provided on the case and connected to the first printed circuit board;
a second connector which is provided on the disk tray and connected to the second printed circuit board, the second connector having a conduction with the first connector when the disk tray is in the first position, and being separated from the first connector when the disk tray is in the second position; and
a positioning mechanism which is provided between the case and the disk tray, and positions the second connector with respect to the first connector when the disk tray moves from the second position to the first position.

2. An optical disk drive apparatus according to claim 1, wherein the positioning mechanism includes:
a projecting portion which is provided in a base portion of the disk tray and tapered from the second position toward the first position; and
a depressed portion which is formed on the case and has a shape complementary with the projecting portion, and into which the projecting portion is inserted when the disk tray is in the first position.

3. An optical disk drive apparatus comprising:
a case;
a disk tray which is movable back and forth between a first position where the disk tray is retracted into the case and a second position where the disk tray projects from the case to the outside;
a first printed circuit board provided outside the case;
a second printed circuit board provided on the disk tray;
a first connector provided inside the case and connected to the first printed circuit board;
a second connector which is provided on the disk tray and connected to the second printed circuit board, the second connector having a conduction with the first connector when the disk tray is in the first position, and being separated from the first connector when the disk tray is in the second position; and
a positioning mechanism which is provided between the case and the disk tray, and positions the second connector with respect to the first connector when the disk tray moves from the second position to the first position.

4. An optical disk drive apparatus according to claim 3, wherein the positioning mechanism includes:
a projecting portion which is formed in a base portion of the disk tray and tapered from the second position toward the first position; and
a depressed portion which is formed on the case and has a shape complementary with the projecting portion, and into which the projecting portion is inserted when the disk tray is in the first position.

5. An optical disk drive apparatus comprising:
a case;
a disk tray which is movable back and forth between a first position where the disk tray is retracted into the case and a second position where the disk tray projects from the case to the outside;
a first printed circuit board provided on the case;
a second printed circuit board provided on the disk tray;
a first connector provided on the case and connected to the first printed circuit board;
a second connector which is provided on the disk tray and connected to the second printed circuit board, the second connector having a conduction with the first connector when the disk tray is in the first position, and being separated from the first connector when the disk tray is in the second position;
an electric power line which connects the first printed circuit board with the second printed circuit board, and supplies electric power from the first printed circuit board to the second printed circuit board; and
a positioning mechanism which is provided between the case and the disk tray, and positions the second connector with respect to the first connector when the disk tray moves from the second position to the first position.

6. An optical disk drive apparatus according to claim 5, wherein the positioning mechanism includes:
a projecting portion which is provided in a base portion of the disk tray and tapered from the second position toward the first position; and
a depressed portion which is formed on the case and has a shape complementary with the projecting portion, and into which the projecting portion is inserted when the disk tray is in the first position.
